(19) United States
(12) Patent Application Publication
(10) Pub. No.: US 2008/0275669 A1
(43) Pub. Date: Nov. 6, 2008

(54) Pedometer

(76) Inventors: Tomohiro Ihashi, Chiba-shi (JP); Keisuke Tsubata, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/082,546

(22) Filed: Apr. 10, 2008

(30) Foreign Application Priority Data
Apr. 13, 2007 (JP) 2007-105528
Jan. 30, 2008 (JP) 2008-019393

(51) Int. Cl. G01C 22/00

(52) U.S. Cl. 702/160

(57) ABSTRACT

To enable to select a walking sensor suitable for detecting walking by short time by a simple constitution in a pedometer using a plurality of walking sensors sensitivity axes of which differ from each other, CPU 108 calculates a step number based on a walking signal from a walking sensor 101a when it is determined that a signal from the first walking detecting circuit 100a including the walking sensor 101a having a priority order at a first order is a walking signal. In a case in which it is determined that the signal is not the walking signal, when a signal from a second walking detecting circuit 100b including a walking sensor 101b a sensitivity axis of which differ from that of the walking sensor 101a, the step number is calculated based on the walking signal of the walking sensor 101b and a priority order of the walking signal 101b is changed to the first order.

### BACKGROUND OF THE INVENTION

1. Field of the Invention

The present invention relates to a pedometer for measuring a step number by detecting walking (including running) of a user, particularly relates to a pedometer including a plurality of sensors having sensitivity axes different from each other.

2. Description of the Related Art

In a related art, a pedometer for calculating a step number of a user has been developed by using a plurality of walking sensors having sensitivity axes different from each other.

For example, a pedometer described in Japanese Patent Publication No. 3543778 is constituted such that a walking sensor whose output is to be an object of counting a step number is selected from a plurality of walking sensors by an operation processing for output signals of the plurality of walking sensors.

Further, a pedometer described in Japanese Patent Publication No. 3624572 is constituted such that an angle sensor is provided separately from a walking sensor, one of outputs of a plurality of walking sensors is selected as a walking signal based on an output of the angle sensor, and a step number is calculated based on the walking signal from the walking sensor.

However, according to the pedometer described in Japanese Patent Publication No. 3543778, for example, even when signals sufficient for counting a step number is outputted from the two walking sensors, an operation processing needs to be carried out for selecting the walking sensor. Therefore, there poses a problem that an operation amount is increased and time is taken for selecting the walking sensor.

Further, although when walking is restarted after temporarily stopping walking, or when a direction of a cabinet is not changed, it is conceivable that the walking sensor selected before being stopped is effective, the pedometer is constituted such that the operation processing is carried out for selecting the walking sensor at each time of starting a step number measuring operation, and therefore, there poses a problem that the operation amount is increased also thereby. Therefore, there poses a problem that time is taken for selecting the walking sensor and there is a concern of bringing about an omission in detecting walking.

On the other hand, according to the pedometer described in Japanese Patent Publication No. 3624572, a circuit scale is increased by increasing a number of parts of the angle sensor or the like, and therefore, there poses a problem that small-sized formation thereof is difficult and the pedometer becomes expensive. Further, the walking sensor is selected based on the output of the angle sensor, and therefore, there poses a problem that the operation amount is increased and time is taken for selecting the walking sensor. Further, there poses a problem that there is a concern of bringing about omission in detecting walking.

### SUMMARY OF THE INVENTION

It is a problem of the invention to enable to select a walking sensor suitable for detecting walking by short time by a simple constitution in a pedometer using a plurality of walking sensors sensitivity axes of which differ from each other.

Further, it is a problem of the invention to restrain occurrence of an omission of detecting walking by enabling to select a walking sensor suitable for detecting walking by short time by a simple constitution.

It is an aspect of the present invention to provide a pedometer which includes a plurality of walking sensors sensitivity axes of which differ from each other and which detect walking and output corresponding walking signals for calculating a step number based on the walking signals, the pedometer including selecting means for selecting one of the walking sensors outputting the walking signals as a walking sensor for detecting walking by switching the plurality of walking sensors, and calculating means for calculating the step number based on the walking signal from the walking sensor selected by the selecting means.

The plurality of walking sensors includes two types, that is, one type in which there are a plurality of pieces of walking sensors for detecting for one sensitivity axis and the other in which there are a plurality of pieces of portions of detecting one sensitivity axis in one element such that, for example, a plurality of detecting portions are formed on a diaphragm.

The selecting means selects one walking sensor outputting the walking signal as the walking sensor for detecting walking by switching the plurality of walking sensors. The calculating means calculates the step number based on the walking signal from the walking sensor selected by the selecting means.

Here, there may be constructed a constitution in which the selecting means switches the plurality of walking sensors by a previously determined order and selects the one walking sensor outputting the walking signal as the walking sensor for detecting walking.

Further, there may be constructed a constitution in which the selecting means switches the plurality of walking sensors by the predetermined order and selects a first walking sensor determined to output the walking signal as the walking sensor for detecting walking.

Further, there may be constructed a constitution including storing means for storing an order of selecting the walking sensor for detecting walking from the plurality of walking sensors, wherein the storing means stores the walking sensor selected for detecting walking by the selecting means as the walking sensor having an order of a first order, and the selecting means switches to select the walking sensor in accordance with the order stored to the storing means.

Further, there may be constructed a constitution including a plurality of walking detecting means including the respective walking sensors, a power source and controlling means for controlling to supply a drive power from the power source to the walking detecting means, wherein the controlling means does not supply the drive power from the power source to the walking detecting means including the walking sensor which is not selected by the selecting means.

Further, there may be constructed a constitution in which the selecting means selects the walking detecting means before being switched during a walking determining period of determining whether the walking is stopped.

Further, there may be constructed a constitution in which when the walking detecting means are switched, the selecting means switches the walking detecting means to detect a signal from the walking detecting means after finishing set up time of the newly selected walking determining means, and the controlling means stops supplying the drive power from the power source to the walking detecting means which is not selected by the selecting means.

Further, there may be constructed a constitution in which the selecting means selects the plurality of walking detecting means by a predetermined order at each predetermined time in a sleep mode and wherein the controlling means supplies the drive power from the power source to the walking detecting means selected by the selecting means.

Further, there may be constructed a constitution in which the selecting means switches the walking detecting means when walking stop time has elapsed without detecting the walking signal after starting to determine walking, and when the walking signal is detected by the walking detecting means within predetermined time after an elapse of set up time of the walking selecting means selected by the selecting means, the calculating means corrects an accumulated step number by calculating a step number generated during a time period until detecting the walking signal by the selected walking detecting means from starting to determine the walking.

Further, there may be constructed a constitution in which the calculating means calculates the step number generated during a time period until detecting the walking signal by the selected walking detecting means from starting to determine the walking based on a period of the walking signal detected by the selected walking detecting means and adds the calculated step number to an accumulated step number to thereby correct the step number.

According to the invention, a walking sensor suitable for detecting walking can be detected by short time by a simple constitution.

Further, according to the invention, occurrence of an omission of detecting walking can be restrained by enabling to select the walking sensor suitable for detecting walking by short time by a simple constitution.

Further, according to the invention, an omission of detecting walking in selecting the walking sensor can be restrained.

### BRIEF DESCRIPTION OF THE DRAWINGS

FIG. 1 is a block diagram of a pedometer according to an embodiment of the invention;

FIGS. 2A, 2B and 2C are timing charts of the pedometer according to the embodiment of the invention;

FIG. 3 is a flowchart showing a processing of the pedometer according to the embodiment of the invention;

FIG. 4 is a flowchart showing a processing of the pedometer according to the embodiment of the invention;

FIG. 5 is a block diagram of a pedometer according to other embodiment of the invention;

FIG. 6 is a flowchart showing a processing of the pedometer according to the other embodiment of the invention;

FIG. 7 is a flowchart showing a processing of the pedometer according to the other embodiment of the invention;

FIG. 8 is a flowchart showing a processing of the pedometer according to the other embodiment of the invention; and

FIG. 9 is a timing chart of the pedometer according to the other embodiment of the invention.

### DETAILED DESCRIPTION OF THE PREFERRED EMBODIMENTS

A pedometer according to an embodiment of the invention will be explained as follows. Further, in respective drawings the same portions are attached with the same notations.

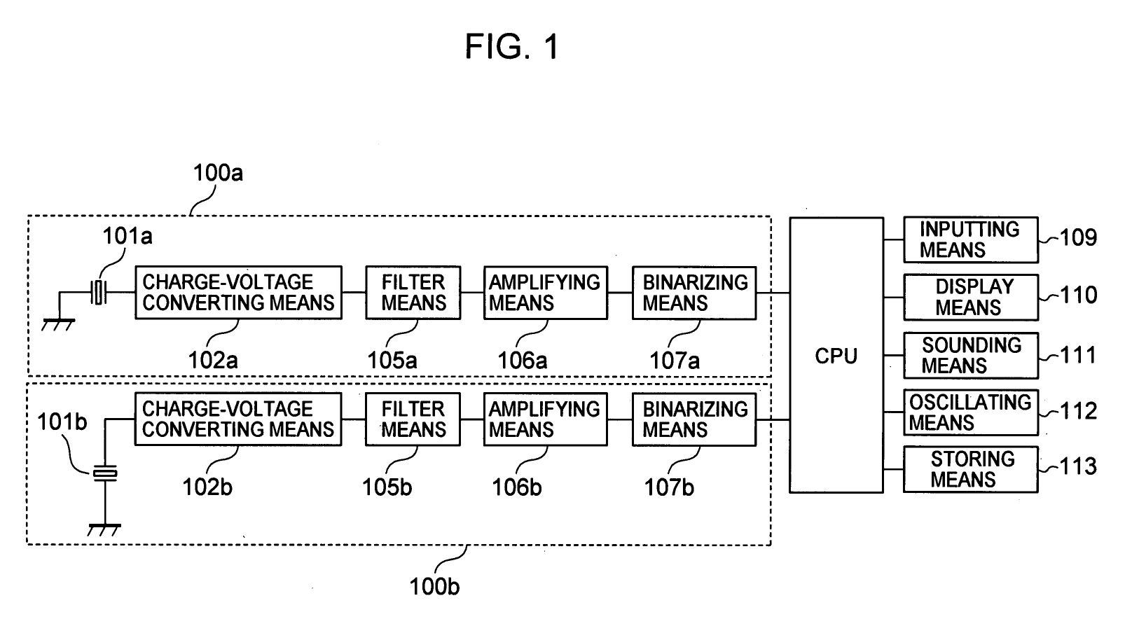

FIG. 1 is a block diagram of a pedometer according to an embodiment of the invention.

In FIG. 1, a pedometer includes a first walking detecting circuit 100a, a second walking detecting circuit 100b, a central processing unit (CPU) 108 for carrying out a step number calculating processing based on walking signals from the first and the second walking detecting circuits 100a and 100b, inputting means 109 constituted by an operation switch or the like for carrying out various operations of a pedometer measurement starting operation and the like, display means 110 for displaying a measured step number or pitch, sounding means 111 for alarming by sound, oscillating means 112 for generating a signal constituting a base of a reference clock signal for CPU 108 and a time signal in carrying out time counting operation, and storing means 113.

The first walking detecting circuit 100a includes a walking sensor (according to the embodiment, a piezoelectric element constituting an acceleration sensor) 101a for outputting a walking signal of a corresponding electric charge at each time of detecting walking of a user, charge-voltage converting means 102a for converting the walking signal from the walking sensor 101a into a walking signal of a corresponding voltage to be output, filter means 105a for outputting a walking signal by removing noise in a signal outputted from the charge-voltage converting means 102a, amplifying means 106a for amplifying to output a walking signal from the filter means 105a, and binarizing means 107a for converting a walking signal in an analog signal type from the amplifying means 106a into a walking signal of a digital signal type.

The second walking detecting circuit 100b is constituted similarly to the first walking detecting circuit 100a. That is, the second walking detecting circuit 100b includes a walking sensor (according to the embodiment, a piezoelectric element constituting an acceleration sensor) 101b for outputting a walking signal of a corresponding electric charge at each time of detecting walking of a user, charge-voltage converting means 102b for converting the walking signal from the walking sensor 101b into a walking signal of a voltage to be output, filter means 105b for outputting a walking signal by removing noise in a signal outputted from charge-voltage converting means 102b, amplifying means 106b for amplifying to output a walking signal from the filter means 105b, and binarizing means 107b for converting a walking signal of an analog signal type from the amplifying means 106b into a walking signal of a digital signal type to output.

The walking sensor 101a and the walking sensor 101b are constituted such that sensitivity axes thereof differ from each other (for example, sensitivity axes differ from each other by 90 degrees).

The walking sensors 101a and 101b can use also other walking sensors of mechanical walking sensors or the like and are not limited to the acceleration sensors of the piezoelectric elements or the like.

The storing means 113 is constituted by ROM stored with a program executed by CPU 108 and RAM used as a work region when CPU 108 executes the program, and RAM is stored with a measured step number and an order or the like of selecting a walking sensor for detecting walking.

CPU 108 can measure time of walking time or the like based on an oscillating signal of the oscillating means 112 in accordance with an operation of the inputting means 109.

The binarizing means 107a and 107b are constituted by comparators having predetermined thresholds.

CPU 108 includes a plurality of input terminals and a step number calculating processing is carried out based on walking signals of a digital signal type inputted from the binarizing means 107a and 107b in correspondence with the selected walking sensors 101a and 101b to the input terminals.

Although not illustrated, a power source for supplying a drive power to the first and the second detecting circuits 100a and 100b is provided and CPU 108 controls not to supply the drive power from the power source to the first walking detecting circuit 100a or the second walking detecting circuit 100b including the walking sensor 101a or the walking sensor 101b which is not selected for detecting walking by CPU 108.

Further, the first and the second walking detecting circuits 100a and 100b respectively constitute first and second walking detecting means and can output binarized walking signals in correspondence with walking of a user to CPU 108. Selecting means is constituted by CPU 108 and by switching the plurality of walking sensors 101a and 101b, one walking sensor for outputting a walking signal in correspondence with walking can be selected as the walking sensor for detecting walking. Further, calculating means is constituted by CPU 108 and the step number can be calculated based on a walking signal from one walking sensor selected by the selecting means. Further, controlling means is constituted by CPU 108, and the drive power can be constituted not to be supplied to the walking detecting circuit including the walking sensor which is not selected by the selecting means.

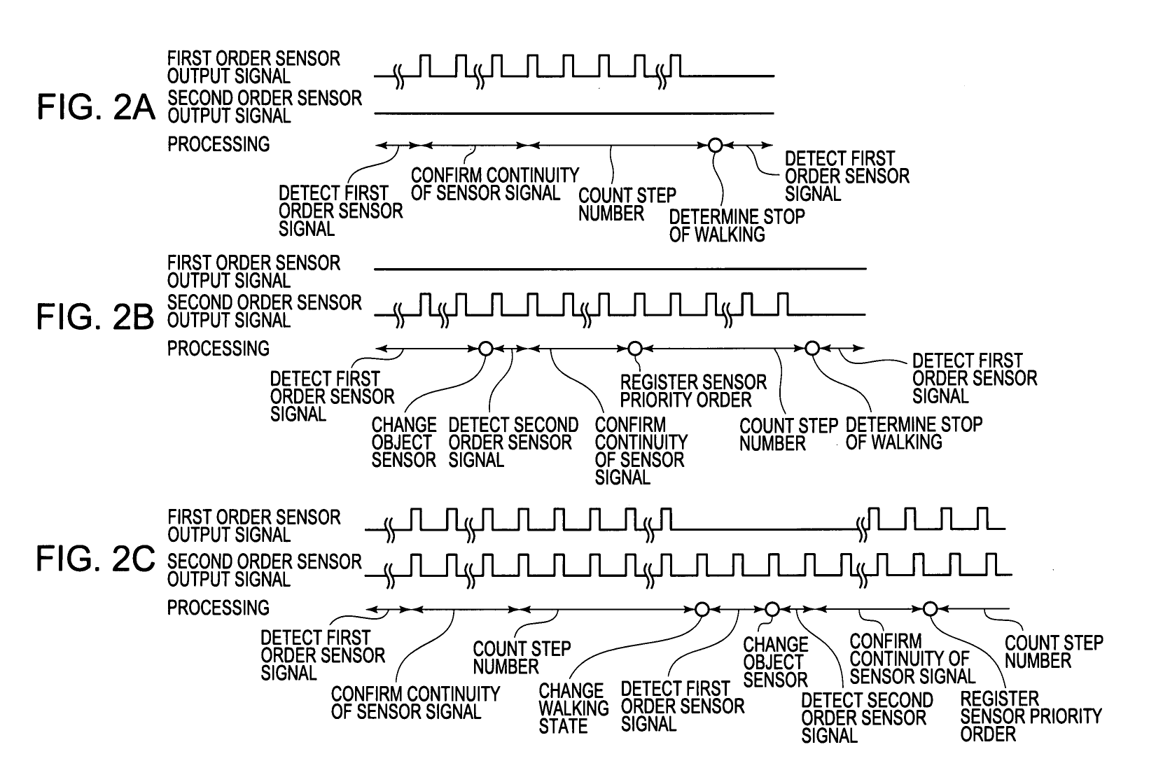

FIGS. 2A, 2B and 2C are timing charts for explaining an operation of the pedometer according to the embodiment.

FIG. 2A shows an example in which although a walking signal is detected by a first order sensor (for example, walking sensor 101a), a walking signal is not detected by a second order walking sensor (for example, walking sensor 101b) and a step number is measured based on the signal from the first order sensor.

Explaining an outline of a processing of CPU 108 in this case, the signal from the first order sensor is determined to be a regular walking signal and is counted as a step number by detecting the signal from the first order sensor and confirming that the signal can be detected continuously for predetermined time (continuity). Walking is determined to stop when the walking signal from the first order sensor is not detected continuously for the predetermined time.

FIG. 2B shows a case inverse to that of FIG. 2A. That is, there is shown an example in which although the walking signal is not detected by the first order sensor (for example, walking sensor 101a), the walking signal is detected by the second order sensor (for example, walking sensor 101b) and the step number is measured by switching the walking signal detecting sensor from the first order sensor to the second order sensor.

Explaining an outline of a processing of CPU 108 in this case, when the signal from the first order sensor cannot be detected for the predetermined time, after switching the walking detecting sensor to the second order sensor, the step number is calculated by determining that the signal from the second order sensor is a regular walking sensor by confirming continuity of the signal from the second order sensor. In this case, a priority order of the second order sensor is switched to the first order (the sensor the order of which has been the first becomes the second order). Further, when the walking signal from the new first order is not detected continuously for the predetermined time, the step number is measured by switching to a new second order sensor.

FIG. 2C shows an example of measuring walking in a state in which the walking signals are detected by both of the first order sensor (for example, walking sensor 101a) and the second order sensor (for example, walking sensor 101b).

Explaining an outline of a processing of CPU 108 in this case, by detecting the signal from the first order sensor and confirming the continuity of the signal, the signal from the first order sensor is determined to be a regular walking signal and is counted as a step number.

When the walking signal from the first order sensor is not detected continuously for the predetermined time because of changing a walking state by a user or the like, the walking detecting sensor is switched to the second order sensor.

CPU 108 determines that the signal from the second order sensor is a regular walking sensor by confirming the continuity of the signal from the second order sensor and calculates the step number based on the walking signal from the second order sensor. In this case, similarly to the above-described, the priority order of the second order sensor is changed to the first order.

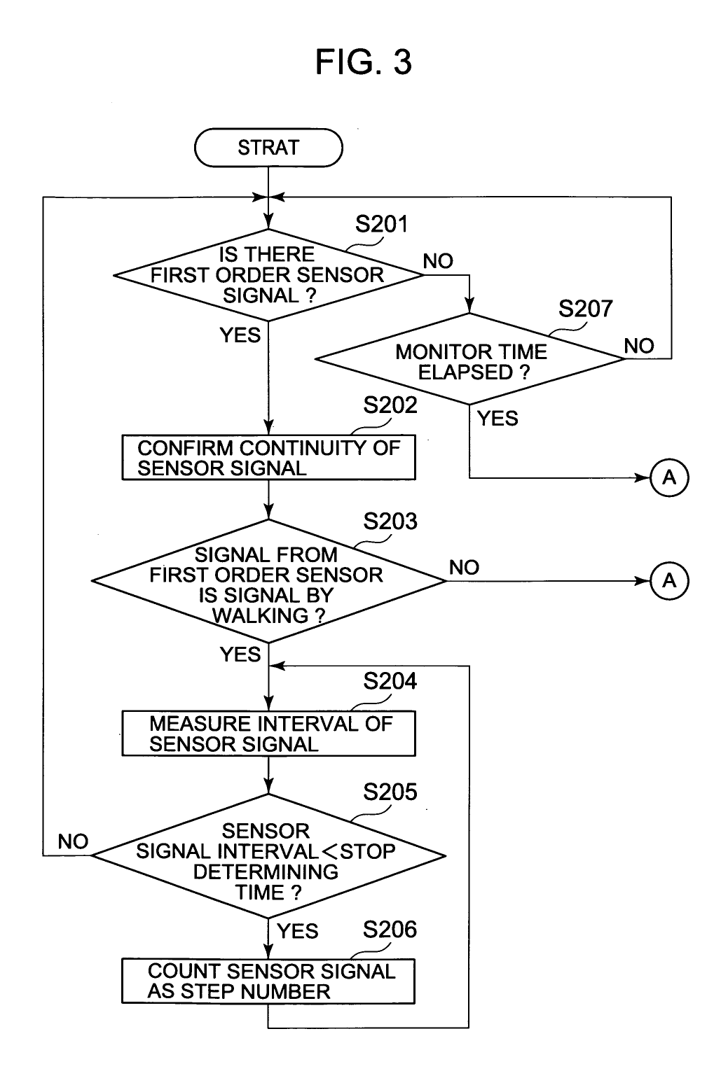

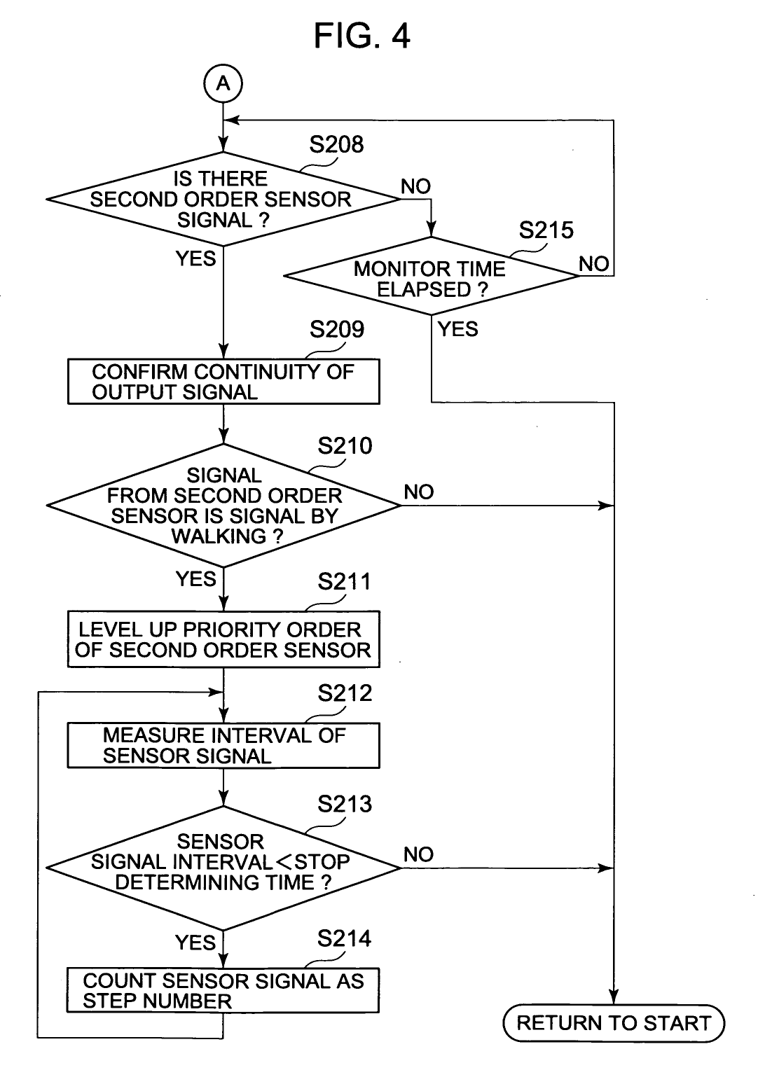

FIG. 3 and FIG. 4 are flowcharts showing a processing of the pedometer according to the embodiment. The processing is mainly carried out by loading the program stored to ROM of the storing means 113 to RAM of the storing means to be executed by CPU 108.

The operation of the pedometer according to the embodiment will be explained in details in reference to FIG. 1 through FIG. 4 as follows.

Assume that before starting the processing of the embodiment, as an initial state, the storing means 113 is stored with the priority orders of selecting the walking sensors 101a and 101b such that the walking signal 101a is the first order and the walking sensor 101b is the second order.

When a step number measuring processing is started by start processing by the inputting means 109 by a user mounted with a pedometer fitted on its own arm or the like, CPU 108 starts to detect walking by supplying the drive power to the first walking detecting circuit 100a including the walking sensor 101a having the priority order of the first order. At the same time, CPU 108 starts measuring time based on a signal generated by the oscillating means 112. At this occasion, the power source is not supplied to the second walking detecting circuits 101b including the walking sensor 101b having the priority order at the second order. Thereby, power saving can be made.

When a user starts walking, the walking sensor 101a detects walking and outputs the corresponding walking signal of electric charge. The walking signal from the walking sensor 101a is converted into the voltage by the charge-voltage converting means 102a, thereafter, amplified by the amplifying means 106a by way of the filter means 105a. The output signal of the amplifying means 106a is converted into the walking signal digitized by the binarizing means 107a, thereafter, inputted to CPU 108.

When it is determined that there is a signal from the first order sensor (in this case, walking sensor 101a) based on the signal from the first walking detecting circuit 100a (step S201), CPU 108 confirms that the signal from the walking sensor 101a is provided continuously for the predetermined time (continuity) (step S202). Here, the predetermined time can be set to time to a degree normally required for walking with 5 steps (for example, 10 seconds).

When the signal from the walking sensor 101a is provided continuously for the predetermined time, CPU 108 determines that the signal from the walking sensor 101a is the walking signal in correspondence with walking (step S203).

Next, CPU 108 measures an interval of the walking signal from the walking sensor 101a (step S204).

When the interval of the walking signal from the walking sensor 101a is smaller than predetermined stop determining time, CPU 108 determines the signal as the walking signal by regular walking (step S205), counts the walking signal from the walking sensor 101a (that is, walking signal from first walking detecting circuit 100a) as the step number and returns it to the processing step S204 (step S206). Here, the stop determining time can be set to time to a degree normally required for walking, for example, with 1 step (for example, 2 seconds).

On the other hand, when the interval of the walking signal from the walking sensor 101a is not smaller than the predetermined stop determining time at the processing step S205, CPU 108 determines that the walking signal is not the walking signal by regular walking and returns to the processing step S201.

When the signal from the walking sensor 101a is determined not to be the signal by walking at the processing step S203, CPU 108 determines that the walking signal is not provided from the walking sensor 101a and proceeds to processing step S208.

Further, also when the state in which there is not a signal from the walking sensor 101a has elapsed for predetermined monitor time at the processing step S201, CPU 108 determines that the walking signal is not provided from the walking sensor 101a and proceeds to the processing step S208 (step S207).

Next, CPU 108 switches the walking sensor used for detecting walking from the walking sensor 101a to the second order sensor (in this case, walking sensor 101b), thereafter, detects the signal from the walking sensor 101b.

When the walking sensor is switched from the walking sensor 101a to the walking sensor 101b, CPU 108 switches supply of the drive power from the first detecting circuit 100a to the second detecting circuit 100b.

Further, although supply of the drive power may be switched to a total of the first and the second walking detecting circuits 100a and 100b, by switching supply of the drive power to portions of constituent elements of the respective walking detecting circuits 100a and 100b, the walking sensors 101a and 101b used for detecting walking may be switched.

When switching of the walking sensors is finished, the walking sensor 101b detects walking and outputs the walking signal corresponding to electric charge. The walking signal from the walking sensor 101b is converted into the voltage by the charge-converting means 102b, thereafter, amplified and outputted by the amplifying means 106b by way of the filter means 105b. The output signal of the amplifying means 106b is converted into the walking signal digitized by the binarizing means 107a, thereafter, inputted to CPU 108.

When it is determined that there is a signal from the walking sensor 101b based on the signal from the second walking detecting circuit 100b (step S208), CPU 108 confirms that the signal from the walking sensor 101b is provided continuously for predetermined time (continuity) (step S209). Here, the predetermined time can be set to time with a degree normally required for walking, for example, with 5 steps (for example, 10 seconds).

When the signal from the walking sensor 101b is provided continuously for the predetermined time, CPU 108 determines that the signal from the walking sensor 101b is the walking signal corresponding to walking (step S210), levels up the priority order of the walking sensor 101b to the first order walking sensor to be stored to the storing means 113 (step S211). Thereby, the order of the walking sensor 101a which has been the first order is leveled down to the second order.

Next, CPU 108 measures an interval of the walking signal from the walking sensor 101b (step S212).

When the interval of the walking signal from the walking sensor 101b is smaller than predetermined stop determining time, CPU 108 determines the signal as the walking signal by regular walking, counts the walking signal from the walking sensor 101b (that is, the second walking detecting circuit 100b) as the step number and returns to the processing step S212 (steps S213, S214). Here, the stop determining time can be set to time with a degree normally required for walking 1 step (for example, 2 seconds).

On the other hand, when the interval of the walking signal from the walking sensor 101b is not smaller than the predetermined stop determining time at the processing step S213, CPU 108 determines that the walking signal is not the walking signal by regular walking and returns to the processing step S201.

When the signal from the walking sensor 101b is determined not to be the signal by walking at the processing step S210, CPU 108 determines that the walking signal is not provided from the walking sensor 101b and returns to the processing step S201.

In this case, CPU 108 does not change the orders of the walking sensor 101a and 101b.

Further, even when a state in which there is not the signal from the walking sensor 101b has elapsed for predetermined monitor time at the processing step S208, CPU 108 determines that the walking signal is not provided from the walking sensor 101b and returns to the processing step S201 (step S215).

As described above, according to the pedometer according to the embodiment, when CPU 108 determines that the signal from the first walking detecting circuit 100a including the walking sensor having the priority order at the first order (for example, walking sensor 101a) is the walking signal, the step number is calculated based on the walking signal from the walking sensor 101a. When it is determined that the signal from the walking sensor 101a is not the walking signal, in a case in which the signal from the second walking detecting circuit 100b including the walking sensor at the second order (for example, walking sensor 101b) having the sensitivity axis different from that of the walking sensor 101a is the walking signal, the step number is calculated based on the walking signal from the walking sensor, 101b and the priority order of the walking sensor 101b is changed from the second order to the first order. The priority order of the walking sensor 101a is changed to a lower order.

In this way, according to the embodiment, in the plurality of walking sensors having the sensitivity axes different from each other, the walking sensor providing the walking signal is simply switched to be selected as the walking sensor for detecting walking. Therefore, there is achieved an effect that a walking sensor suitable for detecting walking can be selected by short time by a simple constitution without carrying out an operation processing for selecting the walking sensor by using the plurality of walking sensors.

Further, the walking sensor suitable for detecting walking can be selected by short time by a simple constitution, and therefore, there is achieved an effect of capable of restraining occurrence of an omission of detecting walking.

Further, although according to the embodiment, two of the walking sensors 101a and 101b are used, the embodiment can be constituted such that two or more of walking sensors having sensitivity axes different from each other are used. For example, in a case of three of walking sensors, the embodiment can be constituted such that the sensitivity axes thereof differ from each other by 90 degrees. In this case, walking detecting circuits including the respective walking sensors are provided and CPU 108 stops supplying the drive power to the walking detecting circuit which is not used for detecting walking.

Further, the monitor time at step S207 at step S215 in the embodiment may be constituted such that the monitor time of the walking sensor having a higher priority order is made to be longer than monitor time of the walking sensor having a lower priority order in consideration of the priority orders of the walking sensors. For example, when walking is restarted after temporarily stopping walking, in a case in which the direction of the cabinet is not changed, it is conceived that the walking sensor having a higher priority order is effective.

Therefore, by monitoring the walking sensor having the higher priority order longer than the walking sensor having the lower priority order, start of walking of the user can be detected earlier and the step number can be detected further accurately.

Further, although according to the embodiment, an explanation has been given by an example of the pedometer of the wristwatch type used by being mounted to the wrist of the user, the embodiment is applicable to various pedometers of a type of being used by being mounted to the waist, of a type of being used in a state of being held by being contained in a bag or the like, a pedometer including a timepiece function or the like.

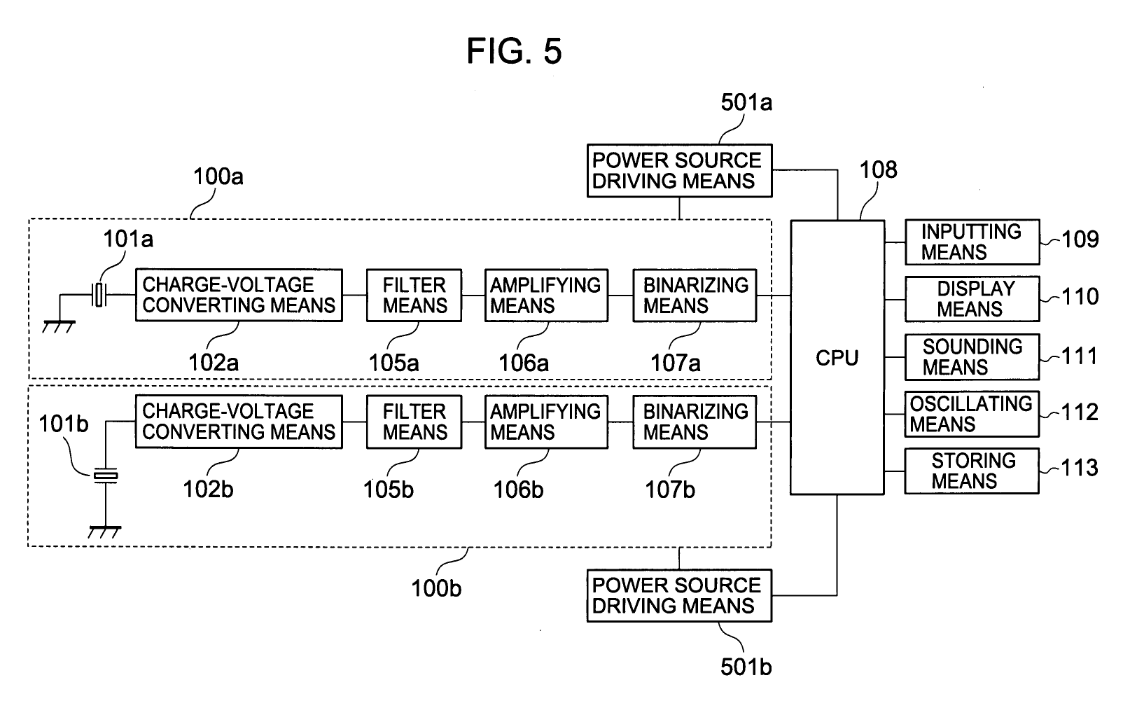

FIG. 5 is a block diagram of a pedometer according to other embodiment of the invention. A point of difference from FIG. 1 resides in including power source driving means 501a and 501b for controlling to supply the drive power to the respective walking detecting circuits 100a and 100b and the other constitution stays the same. Here, CPU 108 and the power source driving means 501a and 501b constitute controlling means.

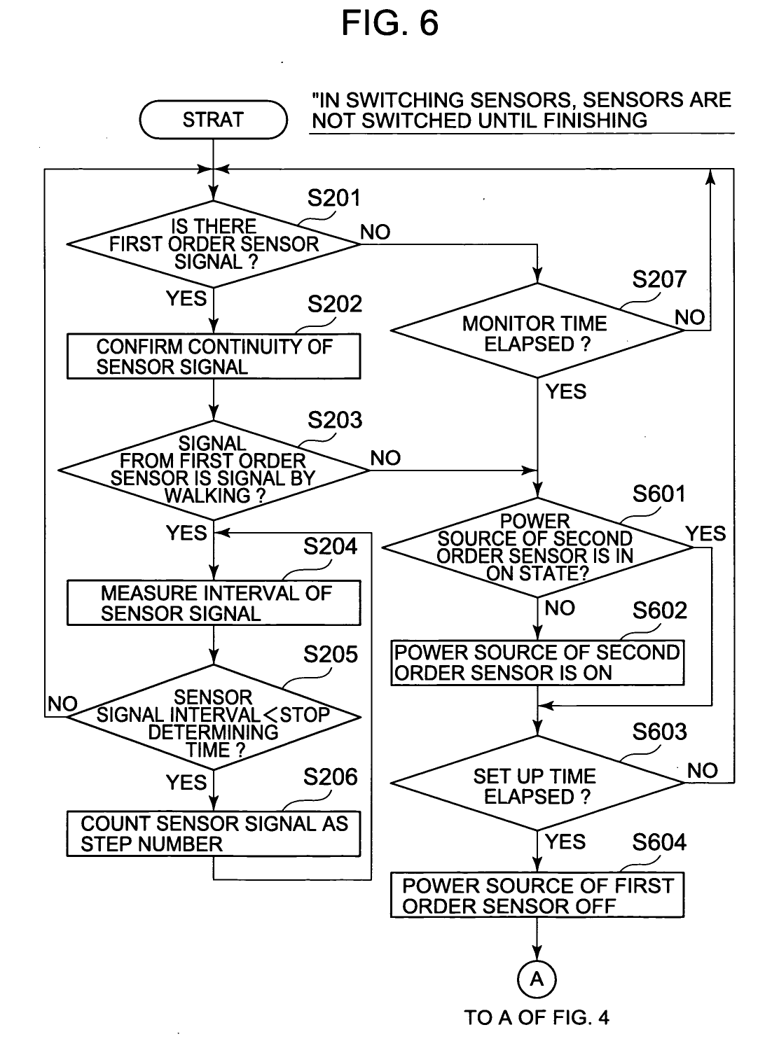

FIG. 6 is a flowchart showing a processing of the other embodiment, showing an example in which when the walking detecting circuits 100a and 100b are switched, until an elapse of time until a newly selected walking detecting circuit 100a or 100b is operated stably after supplying the power source thereto (set up time), the walking signal from the walking detecting circuit 100a or 100b which has been used is detected.

An operation of the pedometer according to the other embodiment will be explained in reference to FIG. 5 and FIG. 6.

When it is determined that there is a signal from the first order sensor (in this case, walking sensor 101a) based on the signal from the first walking detecting circuit 100a (step S201), CPU 108 confirms that the signal from the walking sensor 101a is provided continuously for predetermined time (continuity) (step S202). The predetermined time can be set to time with a degree normally required for walking, for example, with 5 steps (for example, 10 seconds).

When the signal from the walking sensor 101a is provided continuously for the predetermined time, CPU 108 determines that the signal from the walking sensor 101a is a walking signal in correspondence with walking (step S203).

Next, CPU 108 measures an interval of the walking signal from the walking sensor 101a (step S204).

When the interval of the walking signal from the walking sensor 101a is smaller than predetermined time for determining the signal stop of walking (stop determining time), CPU 108 determines the signal as the walking signal by the regular walking (step S205), counts the walking signal from the walking sensor 101a (that is, walking signal from first walking detecting circuit 100a) as the step number and returns to the processing step S204 (step S206). Here, the stop determining time can be set to time with a degree normally required for walking of, for example, with 1 step (for example, 2 seconds).

On the other hand, when a state in which there is not a signal from the walking sensor 101a has elapsed for predetermined monitor time of the processing step S201, CPU 108 determines that the walking signal is not provided from the walking sensor 101a and proceeds to processing step S601 (step S207).

Further, even when it is determined that the signal from the walking sensor 101a is not the walking signal at the processing step S203, CPU 108 proceeds to the processing step S601.

When it is determined that the power source of the second order sensor (in this case, walking sensor 101b) is not brought into an ON state, in other words, the power source driving means 501b does not supply the drive power to the second walking detecting circuit 100b at the processing step S601, CPU 108 supplies the drive power from the power source driving means 501b to the second walking detecting circuit 100b to make the power source of the second walking detecting circuit 100b including the walking sensor 101b ON (step S602).

Next, walking cannot be detected by the walking sensor 101b during time until stabilizing the operation after supplying the power source to the second walking detecting circuit 100b (set up time), and therefore, until the set up time has elapsed, CPU 108 measures the step number by the walking signal detected by the walking sensor 101a. That is, CPU 108 determines whether the set up time has elapsed (step S603), when it is determined that the set up time has elapsed, CPU 108 makes the power source of the first walking detecting circuit 100a including the walking sensor 101a OFF, thereafter, proceeds to the processing step S208 of FIG. 4 to carry out successive processings (step S604). Thereby, walking brought about in the set up time can be detected by the walking sensor 101a, and therefore, occurrence of an omission of detecting walking in switching the walking sensors can be restrained.

When it is determined that the power source of the walking sensor 101b is brought into an ON state, in other words, the power source driving means 501b supplies the drive power to the second walking detecting circuit 100b at the processing step S601, CPU 108 proceeds to the processing step S603 without supplying the drive power to the second walking detecting circuit 100b. Thereby, it can be prevented to make the power source of the second walking detecting circuit 100b ON redundantly.

Further, when it is determined that the set up time has not elapsed at the processing step S603, CPU 108 returns to the processing step S201.

As described above, the pedometer according to the other embodiment detects the step number by selecting the walking detecting circuit 100a or 100b before being switched during the walking determining time for determining whether walking is stopped. Further, when the walking detecting circuits 100a and 100b are switched, the walking detecting circuit is switched to the detecting circuit 100a or 100b after finishing the set up time of the walking detecting circuit 100a or 100b which is newly selected to stop supplying the drive power from the power source to the walking detecting circuit 100a or 100b which is not selected.

In this way, when the walking sensor are switched, the power source of the circuit to be started is made ON in consideration of the set up time of the walking detecting circuit 100a or 100b and the walking detecting circuits 100a and 100b are switched after finishing the set up without switching the circuits until finishing the set up, and therefore, an omission of detecting walking can be restrained in a case in which walking is started during the set up time of the walking detecting circuit 100a or 100b when the walking sensors are switched without receiving the walking signal from the measuring walking sensor.

Further, although when the walking sensors are switched immediately after determining stop of walking, in a case in which the user is temporarily stopped by a traffic signal or the like and restarts walking immediately thereafter, there is a possibility of losing the step number, both of the axes can alternately be monitored continuously as described above, and therefore, an omission of detecting walking can be restrained.

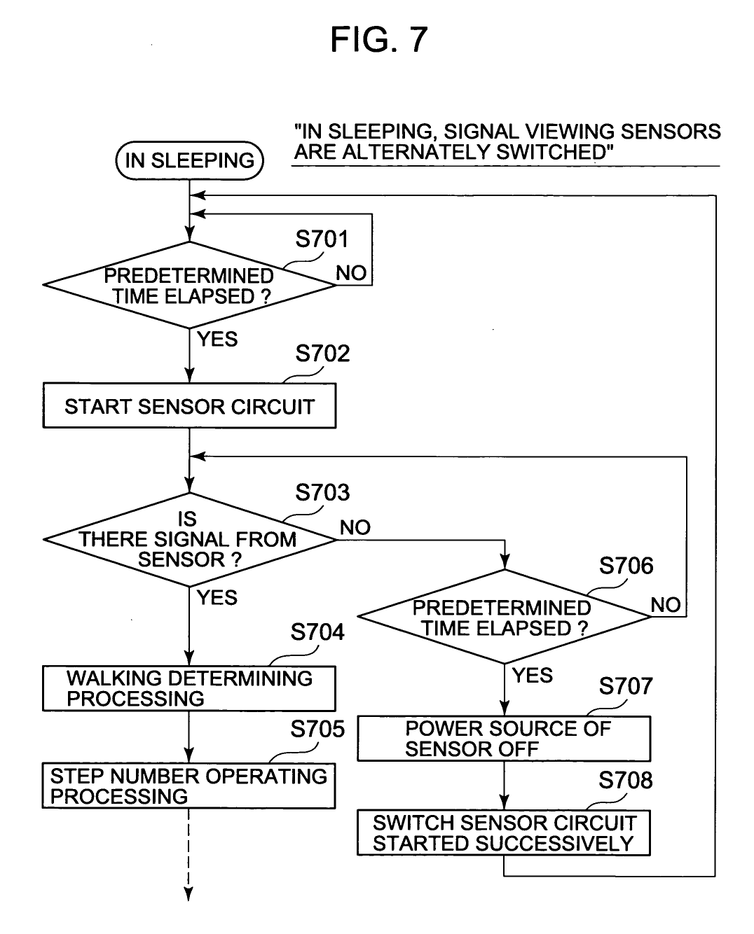

FIG. 7 is a flowchart showing a processing of a pedometer according to still other embodiment, showing an example in which the walking detecting sensors 101a and 101b for detecting walking are alternately switched in a mode (sleep mode) in which it is detected that the walking is being stopped and all of the walking detecting circuits 100a and 100b carry out detecting operation at a predetermined period (intermittent detecting operation).

In FIG. 7, when the walking signal is not detected for predetermined time by all of the walking detecting circuits 100a and 100b, CPU 108 determines stop of walking to be brought into the sleep mode.

When it is determined that the predetermined time (for example, 30 seconds) has elapsed in the sleep mode, CPU 108 controls the power source driving means 501a and 501b to start one of the walking detecting circuits 100a or 100b by supplying the power source thereto (step S702).

When there is a signal from the started walking detecting circuit 100a or 100b (step S703), CPU 108 carries out a walking determining processing (determining processing of a continuity of the sensor signal or a determining processing of whether the signal is by walking) (step S704) and carries out a processing of counting a step number or the like when the walking signal is provided (step S705).

On the other hand, when it is determined that a state in which there is not a signal from the started walking detecting circuit 100a or 100b is continued for predetermined time (for example, 5 seconds) at the processing step S703 (steps S703, S706), CPU 108 makes the power source of the one walking detecting circuit 100a or 100b OFF by controlling the power source driving means 501a or 501b (step S707), switches the walking detecting circuit to the walking detecting circuit 100a or 100b which is started successively, thereafter, returns to the processing step S701 (step S708). A newly switched walking detecting circuit 100a or 100b is started after supplying the power source thereto at the processing step S702.

Thereby, in the sleep mode, the walking detecting circuits 100a and 100b are alternately started at each predetermined time. It is determined whether walking is carried out, and when walking is carried out, the step number is counted and when walking is not carried out, the above-described operation is repeated by starting alternately the walking detecting circuits 100a and 100b.

In this way, in the sleep mode, when the power sources of the walking detecting circuits 100a and 100b are made ON periodically for determining release of sleep, presence or absence of walking is determined by starting only one of the walking detecting circuits 100a and 100b successively, and therefore, sleep releasing time can be determined more accurately than in a case of monitoring only one of the walking detecting circuits 100a and 100b and an increase in consumed current can be prevented.

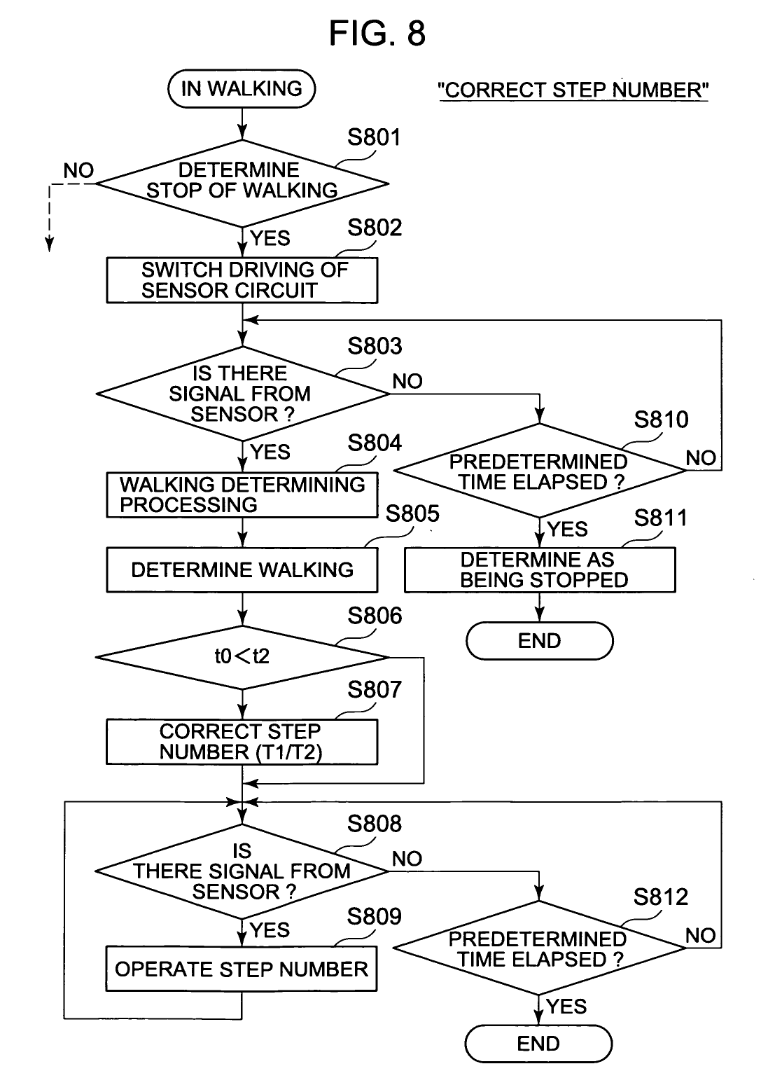

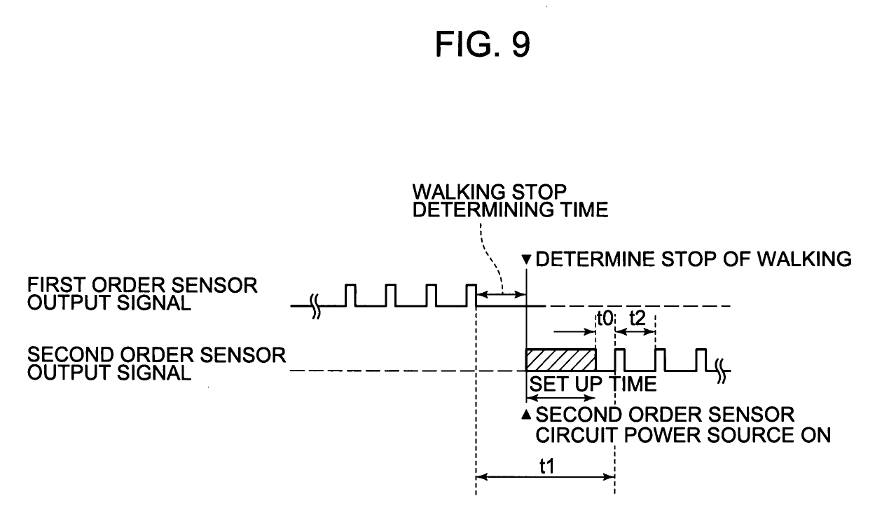

FIG. 8 is a flowchart showing a processing of a pedometer according to still other embodiment, showing an example of correcting a step number. FIG. 9 is a timing chart for explaining a processing of correcting a step number. Further, a block diagram according to the other embodiment is the same as FIG. 5.

In FIG. 5, FIG. 8 and FIG. 9, when it is determined that walking is stopped based on a signal from one of the walking detecting circuits 100a and 100b (step S801), CPU 108 selects other of the walking detecting circuit 100b and 100a to start to switch by controlling the power source driving means 501a or 501b (step S802).

When it is determined that the walking signal is provided from the newly selected walking detecting circuit 100b or 100a (step S803), CPU 108 determines walking by carrying out a walking determining processing (steps S804, S805).

In a case of detecting the walking signal after an elapse of the set up time of the newly selected walking detecting circuit 100b or 100a, when it is determined that time t2 is larger than t0 (step S806), CPU 108 corrects the step number by calculating the step number at time t1 as t1/t2 to add to an accumulated step number (step S807).

Here, as shown by FIG. 9, when the step number detecting circuit 100b or 100a detects the walking signal within predetermined time after elapse of the set up time of the newly selected step number detecting circuit 100b or 100a, time t1 is time until detecting walking by the selected walking detecting circuit 100b or 100a from starting to determine the walking (correcting time). t0 is time until detecting the walking signal after finishing the set up time. Further, time t2 is a period of the walking signal detected after switching the walking detecting circuits.

In this way, according to the other embodiment, when the walking signal can be detected within the predetermined time after finishing the set up time (that is, time t0 is within the predetermined time), the step number correcting processing is carried out by assuming that the walking signal is generated within the correcting time t1. Therefore, the step number can be measured further accurately. Further, although according to the other embodiment, the step number is constituted to be corrected by the walking pitch after the elapse of the set up time, the other embodiment can be modified variously such that the step number is corrected by the walking pitch immediately before starting the walking stop determining time.

Next, when there is the walking signal from the selected walking sensor 101a or 101b (step S808), CPU 108 carries out the step number calculating processing and returns to processing step S808 to repeat to detect walking (step S809).

CPU 108 stops the processing when there is not the walking signal from the selected walking sensor 101a or 101b for the predetermined time at the processing step S808, the processing is finished (step S812).

Further, when there is not the walking signal from the selected walking sensor 101a or 101b for the predetermined time at the processing step S810, CPU 108 determines that walking is being stopped to finish the processing (steps S810, S811).

The invention is applicable to various kinds of pedometers of a type of being used by being mounted to the arm, of a type of being used by being mounted to the waist, of a type of being used in a state of being held by being contained in a bag or the like, a pedometer including a timepiece function or the like.

What is claimed is:

1. A pedometer comprising:
a plurality of walking sensors, wherein sensitivity axes thereof differ from each other and which detect walking to output corresponding walking signals;
selecting means for selecting one of the walking sensors outputting the walking signals as a walking sensor for detecting walking by switching the plurality of walking sensors; and
calculating means for calculating the step number based on the walking signal from the walking sensor selected by the selecting means.

2. A pedometer according to claim 1, wherein the selecting means switches the plurality of walking sensors by a previously determined order and selects the one walking sensor outputting the walking signal as the walking sensor for detecting walking.

3. A pedometer according to claim 1, wherein the selecting means switches the plurality of walking sensors by the predetermined order and selects a first walking sensor determined to output the walking signal as the walking sensor for detecting walking.

4. A pedometer according to claim 2, wherein the selecting means switches the plurality of walking sensors by the predetermined order and selects a first walking sensor determined to output the walking signal as the walking sensor for detecting walking.

5. A pedometer according to claim 1, further including:
storing means for storing an order of selecting the walking sensor for detecting walking from the plurality of walking sensors;
wherein the storing means stores the walking sensor selected for detecting walking by the selecting means as the walking sensor having an order of a first order; and
wherein the selecting means switches to select the walking sensor in accordance with the order stored to the storing means.

6. A pedometer according to claim 2, further including:
storing means for storing an order of selecting the walking sensor for detecting walking from the plurality of walking sensors;
wherein the storing means stores the walking sensor selected for detecting walking by the selecting means as the walking sensor having an order of a first order; and
wherein the selecting means switches to select the walking sensor in accordance with the order stored to the storing means.

7. A pedometer according to claim 3, further including:
storing means for storing an order of selecting the walking sensor for detecting walking from the plurality of walking sensors;
wherein the storing means stores the walking sensor selected for detecting walking by the selecting means as the walking sensor having an order of a first order; and
wherein the selecting means switches to select the walking sensor in accordance with the order stored to the storing means.

8. A pedometer according to claim 4, further including:
storing means for storing an order of selecting the walking sensor for detecting walking from the plurality of walking sensors;
wherein the storing means stores the walking sensor selected for detecting walking by the selecting means as the walking sensor having an order of a first order; and
wherein the selecting means switches to select the walking sensor in accordance with the order stored to the storing means.

9. A pedometer according to claim 1, further including:
a plurality of walking detecting means including the respective walking sensors, a power source and controlling means for controlling to supply a drive power from the power source to the walking detecting means;
wherein the controlling means does not supply the drive power from the power source to the walking detecting means including the walking sensor which is not selected by the selecting means.

10. A pedometer according to claim 9, wherein the selecting means selects the walking detecting means before being switched during a walking determining period of determining whether the walking is stopped.

11. A pedometer according to claim 9, wherein when the walking detecting means are switched, the selecting means switches the walking detecting means to detect a signal from the walking detecting means after finishing set uptime of the newly selected walking determining means; and
wherein the controlling means stops supplying the drive power from the power source to the walking detecting means which is not selected by the selecting means.

12. A pedometer according to claim 10, wherein when the walking detecting means are switched, the selecting means switches the walking detecting means to detect a signal from the walking detecting means after finishing set up time of the newly selected walking determining means; and
wherein the controlling means stops supplying the drive power from the power source to the walking detecting means which is not selected by the selecting means.

13. A pedometer according to claim 9, wherein the selecting means selects the plurality of walking detecting means by a predetermined order at each predetermined time in a sleep mode; and
wherein the controlling means supplies the drive power from the power source to the walking detecting means selected by the selecting means.

14. A pedometer according to claim 10, wherein the selecting means selects the plurality of walking detecting means by a predetermined order at each predetermined time in a sleep mode; and
wherein the controlling means supplies the drive power from the power source to the walking detecting means selected by the selecting means.

15. A pedometer according to claim 11, wherein the selecting means selects the plurality of walking detecting means by a predetermined order at each predetermined time in a sleep mode; and
wherein the controlling means supplies the drive power from the power source to the walking detecting means selected by the selecting means.

16. A pedometer according to claim 12, wherein the selecting means selects the plurality of walking detecting means by a predetermined order at each predetermined time in a sleep mode; and
wherein the controlling means supplies the drive power from the power source to the walking detecting means selected by the selecting means.

17. A pedometer according to claim 10, wherein the selecting means switches the walking detecting means when walking stop time has elapsed without detecting the walking signal after starting to determine walking; and
wherein when the walking signal is detected by the walking detecting means within predetermined time after an elapse of set up time of the walking selecting means selected by the selecting means, the calculating means corrects an accumulated step number by calculating a step number generated during a time period until detecting the walking signal by the selected walking detecting means from starting to determine the walking.

18. A pedometer according to claim 13, wherein the selecting means switches the walking detecting means when walking stop time has elapsed without detecting the walking signal after starting to determine walking; and
wherein when the walking signal is detected by the walking detecting means within predetermined time after an elapse of set up time of the walking selecting means selected by the selecting means, the calculating means corrects an accumulated step number by calculating a step number generated during a time period until detecting the walking signal by the selected walking detecting means from starting to determine the walking.

19. A pedometer according to claim 17, wherein the calculating means calculates the step number generated during a time period until detecting the walking signal by the selected walking detecting means from starting to determine the walking based on a period of the walking signal detected by the selected walking detecting means and adds the calculated step number to an accumulated step number to thereby correct the step number.

20. A pedometer according to claim 18, wherein the calculating means calculates the step number generated during a time period until detecting the walking signal by the selected walking detecting means from starting to determine the walking based on a period of the walking signal detected by the selected walking detecting means and adds the calculated step number to an accumulated step number to thereby correct the step number.
